(19) United States
(12) Patent Application Publication
(10) Pub. No.: US 2009/0106498 A1
(43) Pub. Date: Apr. 23, 2009

(54) COHERENT DRAM PREFETCHER

(76) Inventors: Kevin Michael Lepak, Austin, TX (US); Gregory William Smaus, Austin, TX (US); William A. Hughes, San Jose, CA (US); Vydhyanathan Kalyanasundharam, San Jose, CA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/877,311

(22) Filed: Oct. 23, 2007

(51) Int. Cl. G06F 13/28

(52) U.S. Cl. 711/137

(57) ABSTRACT

A system and method for obtaining coherence permission for speculative prefetched data. A memory controller stores an address of a prefetch memory line in a prefetch buffer. Upon allocation of an entry in the prefetch buffer a snoop of all the caches in the system occurs. Coherency permission information is stored in the prefetch buffer. The corresponding prefetch data may be stored elsewhere. During a subsequent memory access request for a memory address stored in the prefetch buffer, both the coherency information and prefetched data may be already available and the memory access latency is reduced.

### BACKGROUND OF THE INVENTION

1. Field of the Invention

This invention relates to microprocessors and, more particularly, to obtaining coherence permission for speculative prefetched data from system memory.

2. Description of the Relevant Art

In modern microprocessors, one or more processor cores, or processors, may be included in the microprocessor, wherein each processor is capable of executing instructions. Modern processors are typically pipelined wherein the processors include one or more data processing stages connected in series with storage elements placed between the stages. The output of one stage is made the input of the next stage during each transition of a clock signal. Ideally, every clock cycle produces useful execution of an instruction for each stage of the pipeline. In the event of a stall, which may be caused by a branch misprediction, i-cache miss, d-cache miss, data dependency, or other reason, no useful work may be performed for that particular instruction during the clock cycle. For example, a d-cache miss may require several clock cycles to service and, thus, decrease the performance of the system as no useful work is being performed during those clock cycles. The overall performance decline may be reduced by overlapping the d-cache miss service with out-of-order execution of multiple instructions per clock cycle. However, a stall of several clock cycles still reduces the performance of the processor due to in-order retirement that may prevent complete overlap of the stall cycles with useful work.

Further, in various embodiments, system memory may comprise two or more levels of cache hierarchy for a processor. Later levels in the hierarchy of the system memory may include access via a memory controller to dynamic random-access memory (DRAM), dual in-line memory modules (dimms), a hard disk, or otherwise. Access to these lower levels of memory may require a significant number of clock cycles. The multiple levels of caches that may be shared among multiple cores on a multi-core microprocessor help to alleviate this latency when there is a cache hit. However, as cache sizes increase and later levels of the cache hierarchy are placed farther away from the processor core(s), the latency to determine if a requested memory line exists in a cache also increases. Should a processor core have a memory request followed by a serial or parallel access of each level of cache where there is no hit, followed by a DRAM access, the overall latency to service the memory request may become significant.

One solution for reducing access time for a memory request is to use a speculative prefetch request to lower level memory, such as DRAM, in parallel with the memory request to the cache subsystem of one or more levels. If the requested memory line is not in the cache subsystem, the processor sends a request to lower level memory. However, the data may already be residing in the memory controller or may shortly arrive in the memory controller due to the earlier speculative prefetch request. Therefore, the latency to access the required data from the memory hierarchy may be greatly reduced.

A problem may arise with the above scenario when multiple microprocessors in a processing node access the same lower level memory and/or a microprocessor has multiple processing cores that share a cache subsystem. For example, if a first microprocessor in a processing node reads a memory line from a shared DRAM, and later, a second microprocessor writes the same memory line in the shared DRAM, then a conflict arises and the first microprocessor has an invalid memory line. To prevent this problem, in one embodiment, the computing system may use a memory coherency scheme. Such a scheme may notify all microprocessors or processor cores of changes to shared memory lines. An alternative may require a microprocessor to send probes during DRAM accesses, whether the accesses are from a regular memory request or a speculative prefetch. The probes are sent to caches of other microprocessors to determine if the cache line of another microprocessor that contains a copy of the requested memory line is modified or dirty. Effects of the probe may include a change in state of the copy and data movement of a dirty copy in order to update other copies and the memory request.

In another embodiment, a cache line may have an exclusive state, wherein a cache line is clean, or unmodified, and should be present only in the current cache. Therefore, only that processor may modify this cache line and no bus transaction may be necessary. If another processor sends a probe that matches this exclusive cache line, then again, a change in state of the copy and data movement of an exclusive copy may occur in order to update other copies and the memory request. For example, the exclusive cache line may be changed to a shared state. Or the requesting processor may need to wait for the exclusive cache line to be written back to DRAM. Thus, when a processor sends probes during its DRAM accesses, the processor is checking if a cache line in another processor that contains a copy of the requested memory line has an ownership state (i.e. modified, exclusive). As used herein, a cache line with a modified or exclusive state may be referred to as having an ownership state or as an owned cache line.

Responses to a probe, especially of owned cache lines, may require many clock cycles and the latency may be greater than the latency of a memory request to DRAM. Because the prefetched DRAM data may not be used by the requesting microprocessor or core until coherence permission information has been obtained, the large probe latency may negate the benefit gained by the speculative prefetch of DRAM data.

In view of the above, an efficient method for obtaining coherence permission for speculative prefetched data from system memory is desired.

### SUMMARY OF THE INVENTION

Systems and methods for obtaining coherence permission for speculative prefetched data are contemplated.

In one embodiment, a method is provided to issue requests of memory lines. A memory line may be part of a memory block or page that has corresponding information such as a memory address and status information stored by the method. A prediction may determine whether or not a memory line with an address following the current memory access should be prefetched. In response to this prediction, a search may be performed for copies of the prefetched memory line. If copies are found, the corresponding coherency permission information may be read, but not altered. The corresponding data may not be read. During a subsequent memory request for the next memory line, the stored corresponding coherency information may signal a full snoop for copies of the memory line. The full snoop may comprise a second search that may include both modifying the coherency information of the copies in order to alter ownership of the requested memory line and retrieval of the corresponding updated data. However, if during the first search either no copies of the prefetched memory line are found, or only copies which indicate the prefetched memory line has an updated value, such as a copy with a shared state in a MESI protocol, then this corresponding coherency permission may be stored with the prefetched data. During a subsequent memory access request for the memory line, both the coherency information and prefetched data may be already available and the memory access latency is reduced.

In another aspect of the invention, a computer system is provided comprising one or more processors, a memory controller, and memory comprising caches and a lower level memory. During a memory access for a processor, a prediction may determine that a prefetch may be needed of a memory line corresponding to a subsequent memory address. The memory controller may store the subsequent memory address. In response to this prediction, a search may be performed in all caches of the system for copies of the prefetched memory line. If copies are found, the corresponding coherency permission information may be read, but not altered, and sent to the memory controller. The corresponding data may not be read. During a subsequent memory request for the next memory line, the stored corresponding coherency information may signal a full snoop for copies of the memory line. The full snoop may comprise a second search that may include both modifying the coherency information of the copies in order to provide ownership of the requested memory line to the requesting processor and retrieval of the corresponding updated data in a cache. However, if during the first search no copies of the prefetched memory line are found, then this corresponding coherency permission may be stored with the prefetched data in the memory controller. During a subsequent memory access request for the memory line, both the coherency information and prefetched data may be already available and the memory access latency is reduced.

In another aspect of the invention, a memory controller comprises a prefetch buffer. The prefetch buffer may store a memory address of a memory line to be prefetched. In response to an entry being allocated with a memory address, a search may be performed in all caches of the system for copies of the prefetched memory line. If copies are found, the corresponding coherency permission information may be read, but not altered, and stored in the prefetch buffer. The corresponding data of the memory line may not be read. During a processor memory request for a memory address stored in the prefetch buffer, the stored corresponding coherency information may signal a full snoop for copies of the memory line. The full snoop may comprise a second search that may include both modifying the coherency information of the copies in order to provide ownership of the requested memory line to the requesting processor and retrieval of the corresponding updated data in a cache.

However, if during the first search no copies of the prefetched memory line are found, then this information is stored in the prefetch buffer. During a processor memory request for the memory line, both the coherency information and prefetched data may be already available and the memory access latency is reduced.

### BRIEF DESCRIPTION OF THE DRAWINGS

FIG. 1 is a generalized block diagram illustrating one embodiment of a computer system.

FIG. 2A is a generalized timing diagram illustrating one embodiment of a memory access.

FIG. 2B is a generalized timing diagram illustrating another embodiment of a memory access with coherency information already available.

FIG. 3 is a generalized block diagram illustrating one embodiment of a memory controller.

FIG. 4 is a generalized block diagram illustrating one embodiment of a timing sequence of memory accesses in a processing node.

FIG. 5 is a flow diagram of one embodiment of a method for obtaining coherence permission for speculative prefetched data.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

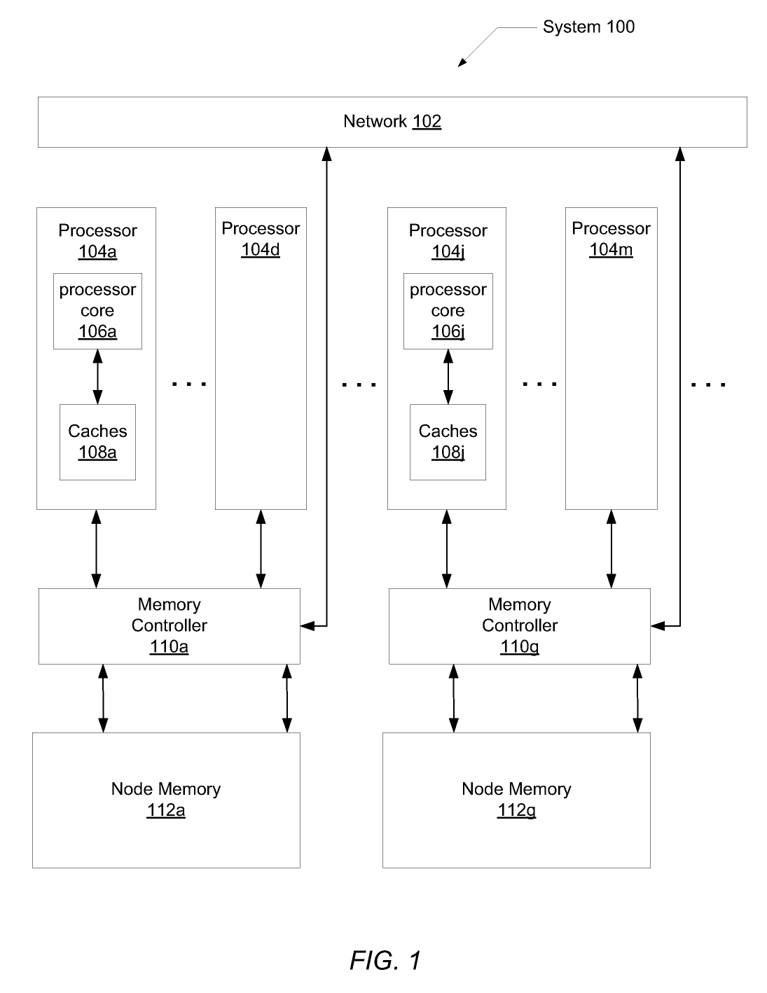

Referring to FIG. 1, one embodiment of a computing system 100 is shown. A network 102 may include remote direct memory access (RDMA) hardware and/or software. Interfaces between network 102 and memory controller 110a-110g may comprise any suitable technology. In one embodiment, an I/O bus adapter may be coupled to network 102 to provide an interface for I/O devices to node memory 112a-112g and processors 104a-104m. I/O devices may include peripheral network devices such as printers, keyboards, monitors, cameras, card readers, hard disk drives and otherwise. Each I/O device may have a device ID assigned to it, such as a PCI ID. An I/O Interface may use the device ID to determine the address space assigned to the I/O device. In another embodiment, an I/O interface may be implemented in memory controller 110a-110g. As used herein, elements referred to by a reference numeral followed by a letter may be collectively referred to by the numeral alone. For example, memory controllers 110a-110k may be collectively referred to as memory controllers 110.

As shown, each memory controller 110 may be coupled to a processor 104. Each processor 104 may comprise a processor core 106 and one or more levels of caches 108. In alternative embodiments, each processor 104 may comprise multiple processor cores. Each core may include a superscalar microarchitecture with a multi-stage pipeline. The memory controller 110 is coupled to system memory 112, which may include primary memory of DRAM for processors 104. In alternative embodiments, system memory 112 may comprise dual in-line memory modules (dimms) in order to bank the DRAM and may comprise a hard disk. Alternatively, each processor 104 may be directly coupled to its own DRAM. In this case each processor would also directly connect to network 102.

In alternative embodiments, more than one processor 104 may be coupled to memory controller 110. In such an embodiment, node memory 112 may be split into multiple segments with a segment of node memory 112 coupled to each of the multiple processors or to memory controller 110. The group of processors, a memory controller 110, and a segment or all of node memory 112 may comprise a processing node. Also, the group of processors with segments of node memory 112 coupled directly to each processor may comprise a processing node. A processing node may communicate with other processing nodes via network 102 in either a coherent or non-coherent fashion. In one embodiment, system 100 may have one or more OS(s) for each node and a VMM for the entire system. In other embodiments, system 100 may have one OS for the entire system. In yet another embodiment, each processing node may employ a separate and disjoint address space and host a separate VMM managing one or more guest operating systems.

In one embodiment, processor core 106 may perform out-of-order execution with in-order retirement. In another embodiment, processor core 106 may fetch, execute, and retire multiple instructions per clock cycle. When a processor core 106 is executing instructions of a software application, it may need to perform memory accesses in order to load and store data values. The data values may be stored in one of the levels of caches 108. Processor 106 may comprise a load/store unit that may send memory access requests to the one or more levels of data cache (d-cache) on the chip. Each level of cache may have its own TLB for address comparisons with the memory requests. Each level of cache 108 may be searched in a serial or parallel manner. If the requested memory line is not found in the caches 108, then a memory request may be sent to the memory controller 110 in order to access the memory line in node memory 112 off-chip. The serial or parallel searches of caches 108, the possible request to the memory controller 110, and the access time of node memory 112 may require a substantial number of clock cycles.

Each of the above steps may require many clock cycles to perform and the latency to retrieve the requested memory line may be large. The retrieved data from node memory 112 via the memory controller 110 may arrive at an earlier clock cycle if a speculative prefetch data request is initiated by the processor 104 or by the memory controller 110. If a cache miss may be predicted with a high level of certainty, then a prefetch request may be sent to the memory controller 110 or it may be initiated by the memory controller 110 in parallel with the already existing memory requests to the caches. If all levels of the caches do miss, then the already existing logic may send a request to the memory controller 110. Now, the requested memory line may arrive sooner or already be stored in the memory controller 110 due to the earlier prefetch request.

However, the prefetched data may not be available for use since its coherency information is still unknown. In one embodiment, system 100 may be a snoop-based system, rather than a directory-based system. Therefore, each time memory controller 110 sends a memory request to node memory 112, memory controller 110 may perform a full snoop of system 100. The full snoop may access each cache 108 in system 100 in order to determine if a copy of the requested memory line resides elsewhere other than in node memory 112. Also, the coherency information needs to be accessed in order to know if another processor core 106 currently has ownership of the requested memory line. In such a case, the coherency information may be changed by the full snoop to allow the current requesting processor core 106 to obtain ownership of the memory line. Also, the owned copy may be sent to memory controller 110 of the requesting processor core 106.

In one embodiment, the full snoop may be implemented with probe commands initiated by memory controller 110. The response time for retrieval of coherency information and a possible owned copy of the data may require a substantial number of clock cycles. Although data of a requested memory line may be retrieved early from node memory 112 by a prefetch initiated by memory controller 110, the data may not be used until its coherency information is known. Therefore, the benefit of a prefetch data retrieval may be lost.

In order to maintain the benefit of a prefetch data retrieval, a snoop of all the caches 108 in system 100 may be initiated at the time of a prefetch to node memory 112. However, this snoop may need to use different probe commands in order to both not modify the coherency information in the caches 108 and not retrieve the data of a copy of the memory line from the caches 108. Such commands may be referred to as a prefetch non-modifying probe commands. The prefetch data from node memory 112 and the coherency information of a prefetch snoop may be stored in memory controller 110. Now, during a memory request in a processor core 106 occurs, if all levels of the caches 108 within the processor 104 do miss, then the already existing logic may send a request to the memory controller 110. The requested memory line along with its coherency information may arrive sooner or already be stored in the memory controller 110 due to the earlier prefetch request and snoop.

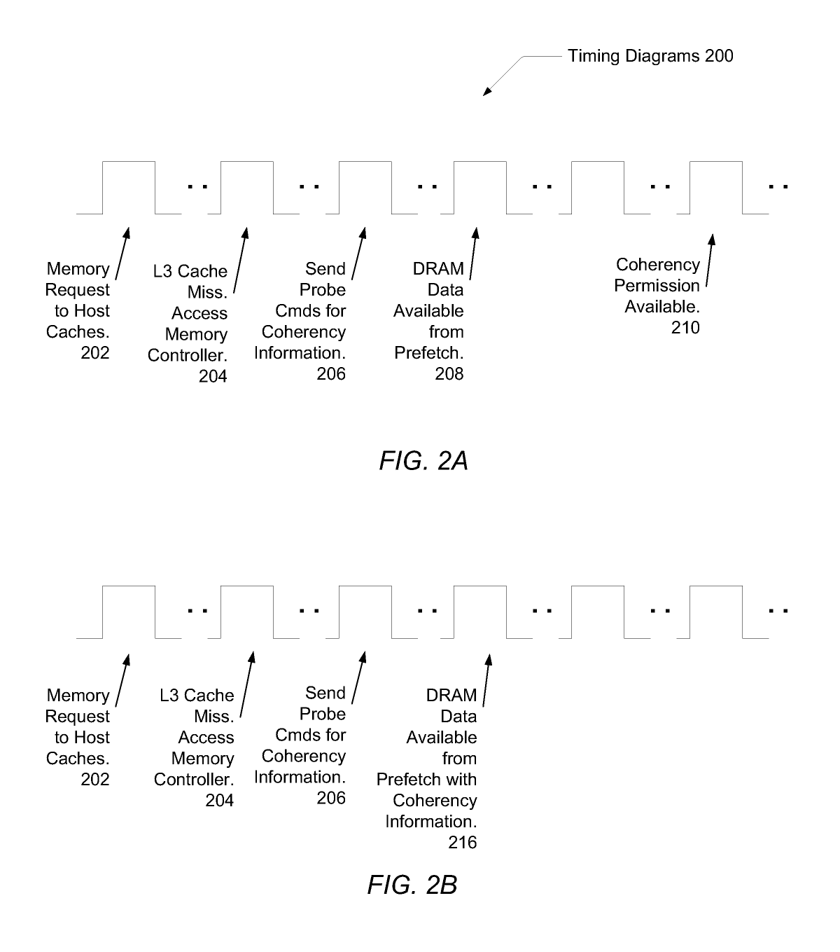

Turning now to FIG. 2A, a timing diagram of multiple clock cycles is shown. For purposes of discussion, the events and actions during clock cycles in this embodiment are shown in sequential order. However, some events and actions may occur in a same clock cycle in another embodiment. A memory request may be sent from a processor core via a load/store unit to a L1 d-TLB and d-cache in clock cycle 202. If the requested memory line is not in the caches and the processor core is connected to three levels of caches, then several clock cycles later, the processor core may receive a L3 miss control signal. The processor core, in the same clock cycle or a later clock cycle, may send out a request to its node memory 204, such as DRAM, via a memory controller. In one embodiment, the memory controller may have a predictor implemented as a table that stores information of past memory requests. The current memory request may be stored in the table. In one embodiment, when predictor logic within the memory controller determines a pattern in memory addresses, such as two or more sequential addresses that needed to access node memory, the predictor may allocate an entry in the table for the next sequential memory address.

For example, a current memory request may have a corresponding memory address A+1. Previously, a memory request may have needed to access memory address A. Entries in the predictor table in the memory controller may be allocated for addresses A and now A+1. In one embodiment, logic within the memory controller may recognize a pattern with the addresses and determine to allocate another entry in the table for address A+2. In another embodiment, logic within the memory controller may capture arbitrary reference patterns or other types of patterns in order to determine how to allocate entries in the table. Now, a request for data may be sent to node memory for address A+1. Also, probe commands may be sent to all caches within the system in order to snoop for copies of the memory line corresponding to address A+1. In one embodiment, a request for data may be sent to node memory for address A+2 in the same clock cycle. If there are not enough ports, in another embodiment, a request for data may be sent to node memory for address A+2 in a subsequent clock cycle.

Later, the processor core may have a memory request for address A+2 such as in cycle 202. The requested memory line may be found to not be in the caches in cycle 204 and the memory request may be sent to the memory controller. Data corresponding to memory address A+2 may already reside in the memory controller due to the earlier prefetch or the data may be on its way to the memory controller due to the earlier prefetch. The memory controller may send probe commands in cycle 206 in order to snoop all caches in the system for copies of the memory line corresponding to address A+2. Also, a prefetch request for a memory line corresponding to address A+3 may be sent to the node memory.

If the corresponding data for address A+2 did not already reside in the memory controller due to the earlier prefetch, it may arrive in clock cycle 208. This arrival of the data may be much earlier than if no prefetch was used. However, the data may not be available for use, since its coherency information is still unknown. The requesting processor may not be able to use the data until it is known this data is the most current valid copy.

In cycle 210, the responses from all other processing nodes may have arrived and the coherency permission information for the memory line corresponding to address A+2 may be known. However, cycle 210 may occur a significant number of cycles after the data is available, and therefore, the benefit of prefetching the data may be reduced or lost.

FIG. 2B illustrates a similar timing diagram as above for a memory request of a processor core. Again, a memory request for a memory line corresponding to address A+1 may be sent from the processor core via a load/store unit to the multiple levels of d-TLB and d-cache. If all the levels of caches within the requesting processor do not contain the requested memory line, then the processor core may be notified of the misses and send a memory request to DRAM via the memory controller in the same or a later clock cycle. A predictor table in the memory controller may have entries allocated for addresses A and now A+1. Logic within the memory controller may recognize a pattern with the addresses and determine to allocate another entry in the table for address A+2. Now, a request for data may be sent to node memory for address A+1. Also, probe commands may be sent to all caches within the system in order to snoop for copies of the memory line corresponding to address A+1. In one embodiment, a request for data may be sent to node memory for address A+2 in the same clock cycle. If there are not enough ports, in another embodiment, a request for data may be sent to node memory for address A+2 in a subsequent clock cycle. In one embodiment, a separate table may allocate an entry for address A+2 corresponding to a prefetch request. Probe commands may be sent to all caches within the system in order to snoop for copies of the memory line corresponding to address A+2.

Later, the processor core may have a memory request for address A+2 such as in cycle 202. The requested memory line may not be found in the caches in cycle 204 and the memory request may be sent to the memory controller. Data corresponding to memory address A+2 may already reside in the memory controller due to the earlier prefetch or the data may be on its way to the memory controller due to the earlier prefetch. Likewise, coherency information corresponding to memory address A+2 may already reside in the memory controller due to the earlier probe commands or the coherency information may be on its way to the memory controller due to the earlier probe commands.

In cycle 206, a prefetch request for a memory line corresponding to address A+3 may be sent to the node memory. Concurrently, the memory controller may send probe commands in cycle 206 in order to snoop all caches in the system for copies of the memory line corresponding to address A+3.

If the corresponding data for address A+2 did not already reside in the memory controller due to the earlier prefetch, it may arrive in clock cycle 216. This arrival of the data may be much earlier than if no prefetch was used. Also, the coherency information for address A+2 may arrive in cycle 216 if the coherency information did not already arrive in the memory controller. This arrival of the coherency information may be much earlier than if no prefetch non-modifying probe commands were used. The data may be available for use, since its coherency information is now known. If the coherency information for address A+2 allows the data to be used, then both the data and the coherency information may be sent from the memory controller to the requesting processor. If the coherency information denotes that another processor other than the requesting processor has exclusive ownership of the data, then probe commands may be sent to snoop all the caches in the system in order to obtain ownership of the data and possibly to retrieve the most current copy of the memory line.

The difference between cycle 210 of FIG. 2A and cycle 216 of FIG. 2B may be a significant number of cycles. The embodiment in FIG. 2B may allow the earlier arrival of data due to a predicted prefetch to maintain an advantage by having the data be ready in the memory controller with its coherency information in the same clock cycle or a clock cycle soon afterwards.

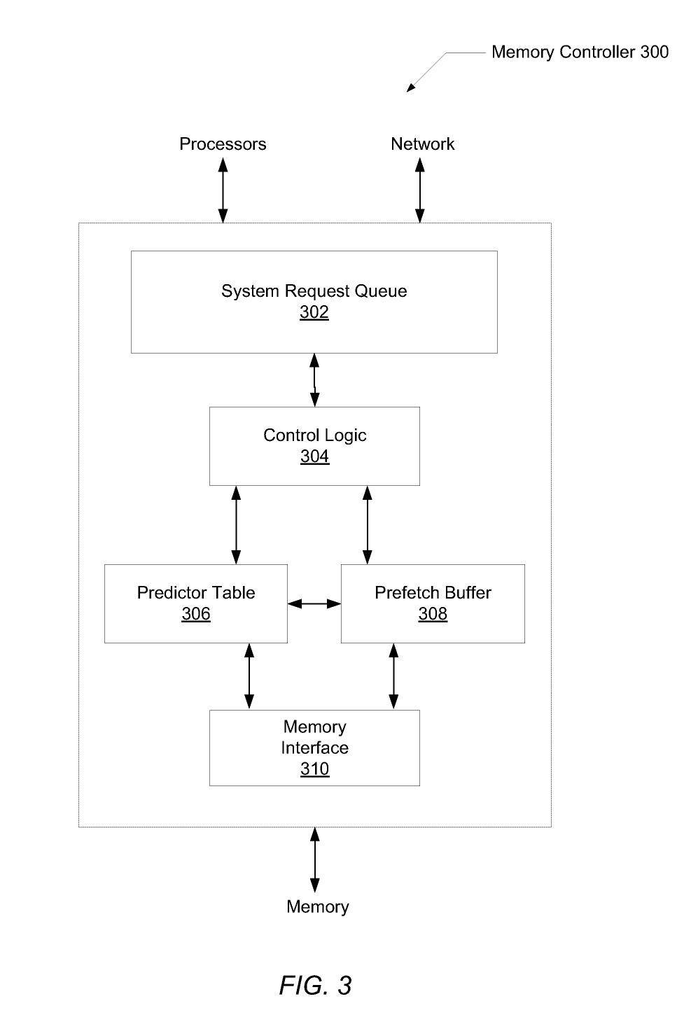

Referring to FIG. 3, one embodiment of a memory controller 300 is shown. The memory controller may comprise a system request queue (SRQ) 302. This queue may send and receive probe commands for snooping of all caches in the system in order to obtain coherency information for a particular memory line. A predictor table 306 may store memory addresses corresponding to memory requests from a processor to memory. Control logic 304 may direct the flow of signals between blocks and determine a pattern of the addresses stored in the predictor table 306. When the control logic 304 determines an address corresponds to a memory line predicted to be requested in a subsequent clock cycle, this address may be allocated in an entry of the prefetch buffer 308. Entries allocated in prefetch buffer 308 may have a data prefetch operation performed using the entry's corresponding address. Memory interface 310 may be used to send the prefetch request to memory. Also, a snoop of all caches in the system may be performed by SRQ 302 for the entry's corresponding address. For entries in the prefetch buffer 308, commands used by SRQ 302 to perform a snoop may be configured to only retrieve cache state information and not update the state information nor retrieve the corresponding data if owned. For entries in the predictor table 306, commands used by SRQ 302 to perform a snoop may be configured to obtain ownership of a memory line, and thus, to update the state information and retrieve the corresponding data if owned.

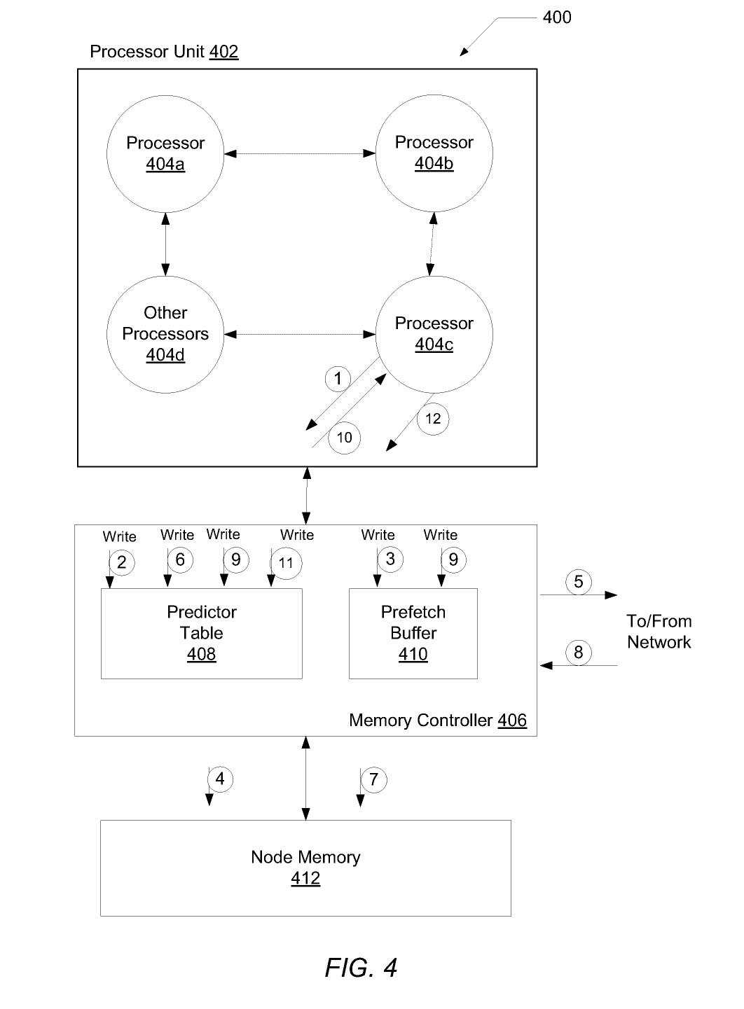

Referring now to FIG. 4, one embodiment of a timing sequence of memory accesses in a processing node 400 is shown. For purposes of discussion, the sequences in this embodiment are shown in sequential order. However, some sequences may occur in a different order than shown, some sequences may be performed concurrently, some sequences may be combined with other sequences, and some sequences may be absent in another embodiment.

A processor unit 402 may contain one or more processors 404 coupled to one another and to a memory controller 406. The memory controller 406 may comprise a predictor table 408 and a prefetch buffer 410. In one embodiment, the node memory 412 for the processing node 400 is coupled to the memory controller and may comprise DRAM. In other embodiments, node memory 412 may be split into segments and directly coupled to the processors 404.

Node memory 412 may have its own address space. Another processing node may include a node memory with a different address space. For example, processor 404b may require a memory line in an address space of a different processing node. Memory controller 406 upon receiving the memory request and address may direct the request to a network in order to access the appropriate processing node.

One example of memory access transactions with a prefetch buffer 410 may include processor 404c submitting a memory access for a memory address A+1 in sequence 1. In this case, the address lies within the address space of this processing node, but it could lie in an address space of another processing node. An entry for address A+1 may be allocated in predictor table 408 in sequence 2. A memory accessing pattern may be recognized by logic within memory controller 406 and an entry may be allocated in prefetch buffer 410 for address A+2 in sequence 3. An access to node memory 412 for address A+1 may occur in sequence 4. A full snoop, or search, for address A+1 of all caches in the system may be sent to the network in sequence 5. This full snoop may alter the cache state information of copies of the memory line corresponding to address A+1 found in other caches and may retrieve an owned copy of the memory line. Concurrently, or afterwards, a snoop for address A+2 may be sent to the network. This snoop only returns information of whether or not a copy of memory line corresponding to address A+2 exists in any of the caches of the system. This snoop may not alter the cache state information of copies of the memory line corresponding to address A+2 found in other caches and may not retrieve an owned copy of the memory line.

In sequence 6, data from node memory 412 corresponding to the memory line with the address A+1 may be returned and written in predictor table 408. In other embodiments, the data may be written to another buffer. An access to node memory 412 for address A+2 may occur in sequence 7. Coherency information for both address A+1 and address A+2 may return in sequence 8 due to the earlier snoop requests. In sequence 9, this information may be written to both predictor table 408 for address A+1 and to prefetch buffer 410 for address A+2.

Both the coherency information and data for address A+1 may be sent to requesting processor 404c in sequence 10. In sequence 11, data from node memory 412 corresponding to the memory line with the address A+2 may be returned and written in predictor table 408. In other embodiments, the data may be written to prefetch buffer 410 or another buffer. Requesting processor 404c may send a memory access request for address A+2 in sequence 12. Both the data and coherency information for address A+2 may be available in memory controller 406 and the latency for the memory request may be reduced.

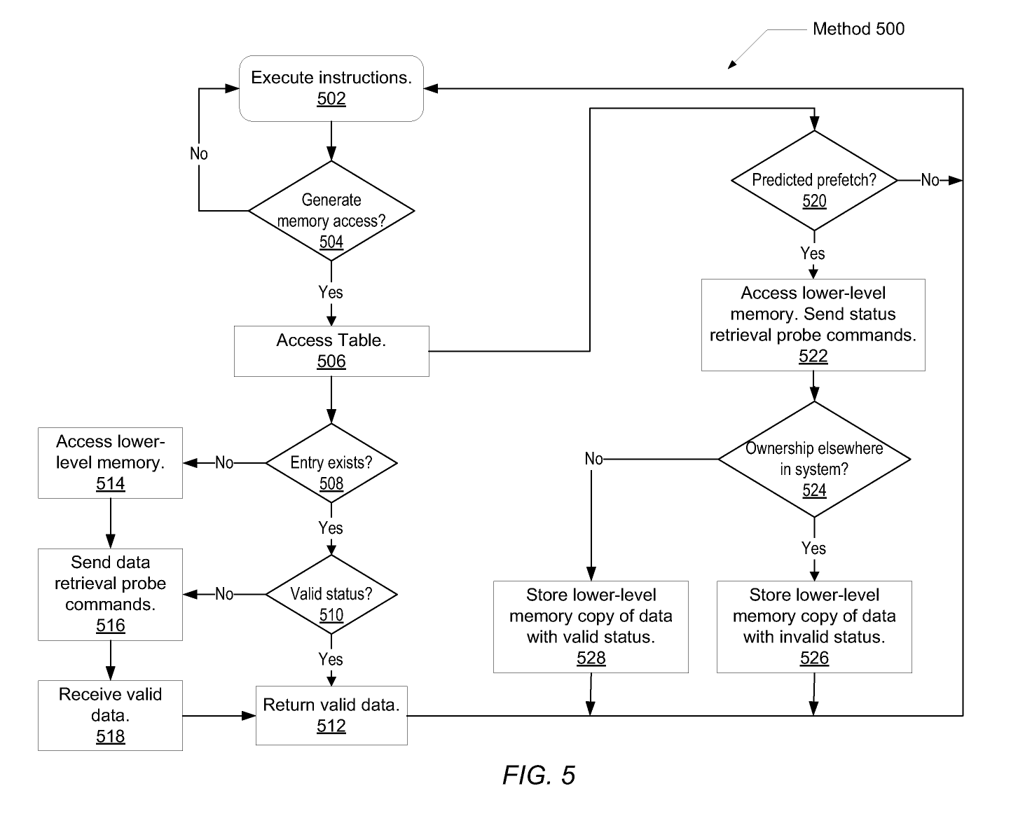

FIG. 5 illustrates a method of one embodiment of a method for obtaining coherence permission for speculative prefetched data. For purposes of discussion, the steps in this embodiment are shown in sequential order. However, some steps may occur in a different order than shown, some steps may be performed concurrently, some steps may be combined with other steps, and some steps may be absent in another embodiment. In the embodiment shown, a processor may be executing instructions (block 502). Memory access instructions, such as load and store instructions, may need to be executed by a processor (decision block 504). An address may be calculated for a memory access instruction, and later, the instruction may be sent to a memory controller (block 506). In one embodiment, logic within the memory controller may determine a pattern among the present and/or past memory access addresses and make a prediction that the next sequential address may be needed (decision block 520). In other embodiments, a prediction may be made for other reasons. Additionally, predictions may be made in a location other than the memory controller, such as the processor itself.

When a data access occurs for a predicted prefetch of a memory line, a search may be performed of all the caches in the system for copies of the prefetched memory line (block 522). If a copy of the prefetched memory line is found, the returned coherency information may be stored with the prefetched data. The prefetched coherency information notifies the memory controller that the prefetched data corresponding to the current memory request may be owned by another processor (decision block 524). If another processor has ownership, an invalid status may be stored with the returned coherency information and prefetched data in block 526 in order to signal a later full snoop. The coherency information stored with the copy of the memory line in other cache(s) may not be altered and the data may not be returned with the copy of the coherency information. When the processor receives coherency information and data of the original memory access, it may later send a request for the memory line that was prefetched. A full snoop for the memory line may be issued in order for the requesting processor to obtain both ownership of the memory line and a copy of the possibly owned data.

If a copy of the prefetched memory line is found with returned coherency information that notifies another processor does not have ownership or a copy of the prefetched memory line is not found (decision block 524), the returned coherency information may be stored with the prefetched data in block 528. When the processor receives coherency information and data of the original memory access, it may later send a request for the memory line that was prefetched. The prefetched coherency information notifies the memory controller that the prefetched data corresponding to the current memory request may not be owned by another processor. The prefetched data may be sent to the requesting processor and the latency for the memory access may be greatly reduced.

In one embodiment, an entry in a table in the memory controller may store a memory address and corresponding coherency permission information, data, and status information of the memory line. In one embodiment, the following actions may occur in parallel with the above description. If an entry in the table exists for a data access from the processor (decision block 508), and the corresponding coherency permission denotes that the data is valid for use (decision block 510), then the data stored in the entry may be sent to the requesting processor in block 512. In this case, no access to lower-level memory may be needed and no snoop of other caches in the system may be needed. The latency for the memory access may be greatly reduced.

Again, if an entry in the table exists for a data access (decision block 508), but the corresponding coherency permission denotes that the data is invalid for use (decision block 510), a full snoop of all caches in the system except for caches in the requesting processor may be needed to search for copies of the memory line. Data retrieval probe commands may be used to perform the search in block 516. A valid copy of the memory line may exist in a cache of another processor. That particular copy may need to have its coherency permission information altered to grant ownership to the requesting processor and the data of that copy needs to be sent to the memory controller. The data retrieval probe commands may perform these functions. The memory controller may later receive the valid copy of the data of the requested memory line in block 518. The absence of an access to lower-level memory may not reduce the latency of the memory access since the data retrieval probe commands may require substantial time to execute. However, resources for accessing lower-level memory corresponding to the memory controller are not used and therefore these resources are available to other processors.

If an entry in the table of the memory controller does not exist for the data access (decision block 508), then in block 514 the lower-level memory may be accessed to find the requested memory line data. Also, an entry may be allocated for the data access. The steps in blocks 516 and 518 are performed as described above.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
initiating a memory access for a first memory line, the memory access being initiated by a processor;
allocating an entry and storing information corresponding to a second memory line in the allocated entry, the second memory line being predicted to be required in a subsequent memory access operation;
searching cache subsystems of a computing system for copies of the second memory line, in response to said allocating;
receiving status information corresponding to said second memory line, in response to said searching; and
storing said status information in the allocated entry.

2. The method as recited in claim 1, wherein in response to a cache hit as a result of said searching, no change in ownership status of the memory line results from the cache hit.

3. The method as recited in claim 2, wherein said allocating is in response to predicting said memory line will be required on a subsequent memory access operation.

4. The method as recited in claim 1, further comprising prefetching said second memory line.

5. The method as recited in claim 4, further comprising conveying said prefetched second memory line to the processor, in response to detecting:
a request by the processor for the second memory line; and
said status information indicates said prefetched second memory line is valid.

6. The method as recited in claim 4, further comprising searching said cache subsystems for a valid copy of the second memory line, in response to detecting:
a request by the processor for the second memory line; and
said status information indicates said prefetched second memory line is not valid.

7. The method as recited in claim 1, further comprising storing a memory block address and memory line cache status corresponding to the memory block address.

8. A computer system comprising:
a processing unit comprising a plurality of processors;
a cache subsystem coupled to each processor; and
a memory controller comprising a plurality of entries coupled to the processing unit;
wherein the memory controller is configured to:
store information in an entry corresponding to a memory block, the memory block comprising a memory line predicted to be required in a subsequent memory access operation;
allocate a new entry of the plurality of entries for the memory block;
search cache subsystems of the computing system for copies of the memory block, in response to the allocating the new entry;
store status information of a copy of the memory block from the cache subsystem in the new allocated entry, in response to a hit in the cache subsystem.

9. The system as recited in claim 8, wherein the memory controller is further configured to, in response to a new allocated entry of the plurality of entries, not obtain exclusive ownership of a memory line in a cache subsystem for a cache hit.

10. The system as recited in claim 9, wherein the memory controller is further configured to, in response to a memory line predicted to be required in a subsequent memory access operation, allocate a new entry of the plurality of entries.

11. The system as recited in claim 10, wherein the memory controller is further configured to, in response to an entry of the plurality of entries selected by a memory access operation, convey data of the corresponding memory line to a requesting processor if the status information is clean.

12. The system as recited in claim 10, wherein the memory controller is further configured to, in response to an entry of the plurality of entries selected by a memory access operation, search for updated data of the corresponding memory line if the status information is modified or exclusive.

13. The system as recited in claim 11, wherein each of the entries is configured to store a memory block address and memory line cache status corresponding to the memory block address.

14. A memory controller, in one processing node within a computing system comprising a plurality of processing nodes, comprising:
a plurality of entries, wherein each of the entries is configured to store information corresponding to a memory block, the memory block comprising a memory line predicted to be required in a subsequent memory access operation; and
control logic, wherein the control logic is configured to:
search cache subsystems of the computing system for copies of the memory block; and
store status information of the copy of the memory block from the cache subsystem in the new allocated entry, in response to a hit in a cache subsystem.

15. The memory controller as recited in claim 14, wherein the control logic is further configured to, in response to a new allocated entry of the plurality of entries, not obtain exclusive ownership of a memory line in a cache subsystem for a cache hit.

16. The memory controller as recited in claim 15, wherein the control logic is further configured to, in response to a memory line predicted to be required in a subsequent memory access operation, allocate a new entry of the plurality of entries.

17. The memory controller as recited in claim 16, wherein the control logic is further configured to, in response to an entry of the plurality of entries selected by a memory access operation, convey data of the corresponding memory line to a requesting processor if the status information is clean.

18. The memory controller as recited in claim 17, wherein the control logic is further configured to, in response to an entry of the plurality of entries selected by a memory access operation, search for updated data of the corresponding memory line if the status information is modified or exclusive.

19. The memory controller as recited in claim 14, wherein each of the entries is configured to store a memory block address and memory line cache status corresponding to the memory block address.
